(19) United States
(12) Patent Application Publication
(10) Pub. No.: US 2006/0212336 A1
(43) Pub. Date: Sep. 21, 2006

(54) Smart, web-based time management software

(75) Inventors: Daniel Powers, Frisco, CO (US); Cindy Muesing, Highlands Ranch, CO (US)

Correspondence Address: Starkweather and Associates, Suite 200, 9035 South 1300 East, Sandy, UT, 84094, US

(73) Assignee: High Altitude Software

(21) Appl. No.: 11/086,018

(22) Filed: Mar. 21, 2005

(51) Int. Cl. G06F 15/02

(52) U.S. Cl. 705/9

(57) ABSTRACT

A novel software method of creating and maintaining a schedule of the activities to be performed by agents on behalf of a principal entity at least includes: a) creating a principal profile; b) identifying the principal's agents; c) defining jobs to be performed by the principal's agents, the jobs being at least partially defined by identifiable skills needed to perform the jobs; d) defining a scheduling period; e) defining job shifts related to the temporal performance of the jobs during a scheduling period; f) defining job criteria for matching particular agents to particular jobs; g) identifying the availability of the principal's agents for job shift performance; h) generating a job shift schedule based on elements b)-g); i) automatically modifying the job shift schedule according to predefined rules and interpreted rules postulated by software according to previous scheduling and scheduling approval iterations; j) determining a fitness value of a generated or modified schedule, based on adherence to predefined or interpreted rules; k) repeating elements i) and j) until no improvement in the fitness value is realized; l) via a principal's manager-agent, approving a job shift schedule; and m) publishing an approved job shift schedule for availability to the principal's agents and manager-agents. The method is hosted via the Internet, using an application service provider model.

### FIELD OF THE INVENTION

The present invention generally relates to time management regarding employees and the workplace, and specifically relates to software implements of the same.

### DESCRIPTION OF THE RELATED ART

Pressures on the productivity of workers and the profitability of businesses have led to an embracing of technology in the workplace-especially with respect to software. Along with the efficient management of product inventories, and manufacturing and assembly processes, as well as the purchase and delivery of products, such efficient management is also being increasingly applied to human capital. To that end, scheduling and calendar software has been developed to track work and employee activities, as well as to schedule shifts.

The vagaries of the modern economy (e.g., changes in product or service lines, just-in-time delivery, changes in the demand for products or services, etc.), as well as the dynamic nature of workers' personal and family lives (e.g., unscheduled sick leave, vacation days, time away from work to upgrade skills or education, etc.), often make simple approaches to workplace time management ineffective.

What is needed, but not provided for in the prior art, is smart time management software that teaches itself to generate high quality schedules that efficiently utilize human capital. There is also a need to provide such software with the flexibility needed for workplace managers to modify schedules and to approve schedules before they are published.

There is a further need to provide time management software (and published schedules) as described supra, which can be accessed via the Internet. Further desired refinements to such a time management software system include allowing published schedules and information input to generate the schedule, to be multilingual.

### SUMMARY OF THE INVENTION

The present invention has been developed in response to the present state of the art, and in particular, in response to the problems and needs in the art that have not yet been fully solved by currently available time management systems. Accordingly, the present invention has been developed to provide a software method of creating and maintaining a schedule of the activities to be performed by agents on behalf of a principal entity. The method at least includes: a) creating a principal profile; b) identifying the principal's agents; c) defining jobs to be performed by the principal's agents, the jobs being at least partially defined by identifiable skills needed to perform the jobs; d) defining a scheduling period; e) defining job shifts related to the temporal performance of the jobs during a scheduling period; f) defining job criteria for matching particular agents to particular jobs; g) identifying the availability of the principal's agents for job shift performance; h) generating a job shift schedule based on elements b)-g); i) automatically modifying the job shift schedule according to predefined rules and interpreted rules postulated by software according to previous scheduling and scheduling approval iterations; j) determining a fitness value of a generated or modified schedule, based on adherence to predefined or interpreted rules; k) repeating elements i) and j) until no improvement in the fitness value is realized; l) via a principal's manager-agent, approving a job shift schedule; and m) publishing an approved job shift schedule for availability to the principal's agents and manager-agents.

The present invention has also been developed to provide a software module capable of carrying out the above-described method. In the preferred embodiment, the software module is accessible via the Internet, using an application service provider scheme.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a schematic diagram of a system capable of implementing the present-inventive web-based time management method;

FIG. 2A illustrates the first portion of a flowchart detailing the general steps in the present-inventive web-based time management method; and

FIG. 2B illustrates the remaining portion of the flowchart began in FIG. 2A, detailing the general steps in the present-inventive web-based time management method.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment.

Used in connection with the description below, agent, a broad legal term encompassing other terms such as servant and employee, generally means one who performs on behalf of another for that other's benefit. Principal, a broad legal term encompassing other terms such as master and employer, generally means one on whose behalf an agent performs. Agents and principals may be individuals as well as entities, although in the preferred embodiment described below, agents are typically individuals performing employment-related activities.

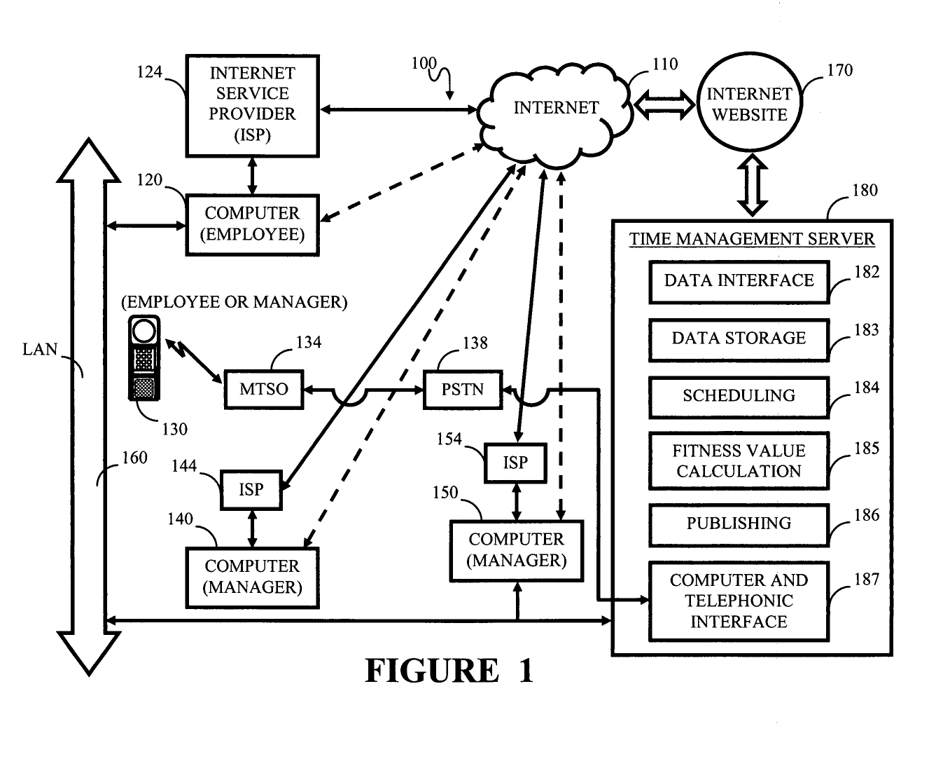

The nominal components for a system 100 capable of implementing the present-inventive, smart, web-based time management method, is shown in FIG. 1. The time management software of the present invention resides on a time management server 180 in the preferred embodiment, although the location of the software can vary in practice. The server 180 can be maintained by a company serving as the principal entity. Agents of the principal who are employees or employee-managers can access the time management software, or receive messages generated by the time management software from a variety of sources.

The server 180 is connected to a website 170 hosted by the principal via the Internet/World Wide Web 110. As the time management software resides on the back end of the system, the present invention uses an application service provider model for carrying out time management. This reduces the hardware and software requirements at the front end of the system. A variety of devices and instrumentalities on the front end of the system can be used for data input and software control functions, such as a computer 120 operated by a non-management employee and coupled to the Internet 110 via an Internet Service Provider (ISP) 124. In an alternate embodiment, the computer 120 couples directly to the Internet without the use of an ISP.

Additional computers 140 and 150, or even other digital communication devices such as Personal Data Assistants (PDAs), used by management-employees may connect to the server 180. The computers 140 and 150 may optionally connect to the Internet 110 via ISPs 144 and 154, respectively.

Agents (either management employees or non-management employees) of the principal company can also input data and commands, as well as receive communications from the system back end, via telephonic devices such as a cellular telephone 130. The cellular communications are handled by a Mobile Telephone Switching Office (MTSO) 134 and the larger Public Switched Telephone Network (PSTN) 138, as will be appreciated by those skilled in the art.

In the versatile example of FIG. 1, communication with the back end can also occur through a Local Area Network (LAN) 160.

The software on the time management server 180 is administered by several modules symbolically shown in FIG. 1. These modules include a data interface 182, data storage 183, job shift scheduling/scheduling generation 184, fitness value calculation 185 (as will be explained infra.), job shift schedule publishing 186, and a computer and telephonic interface 187.

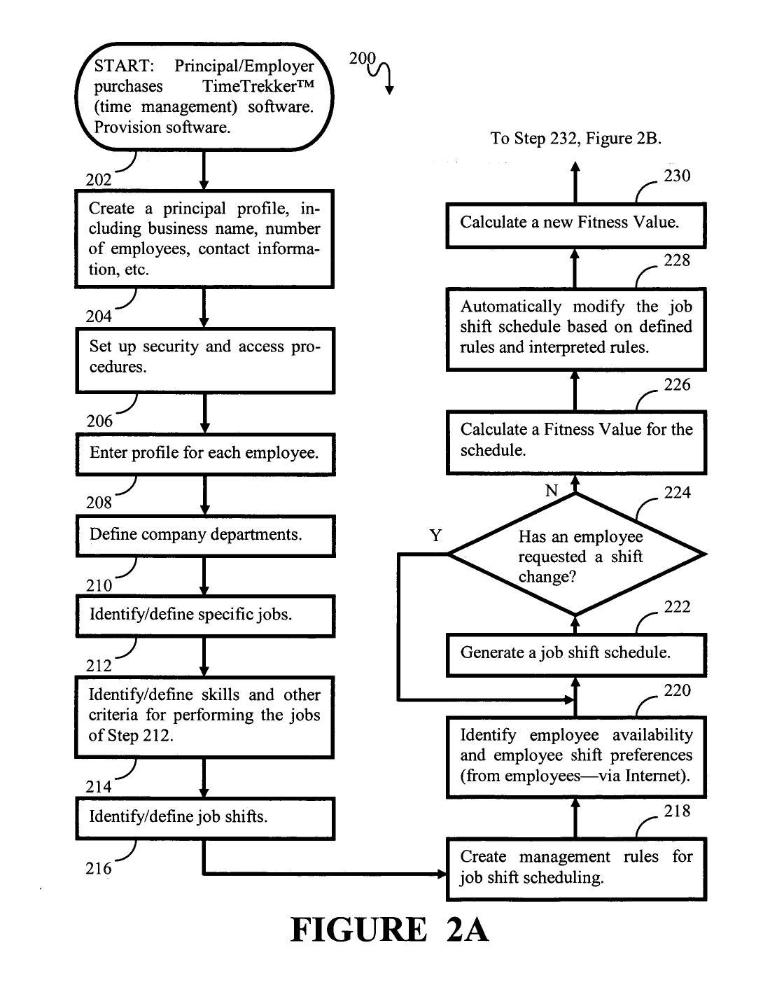

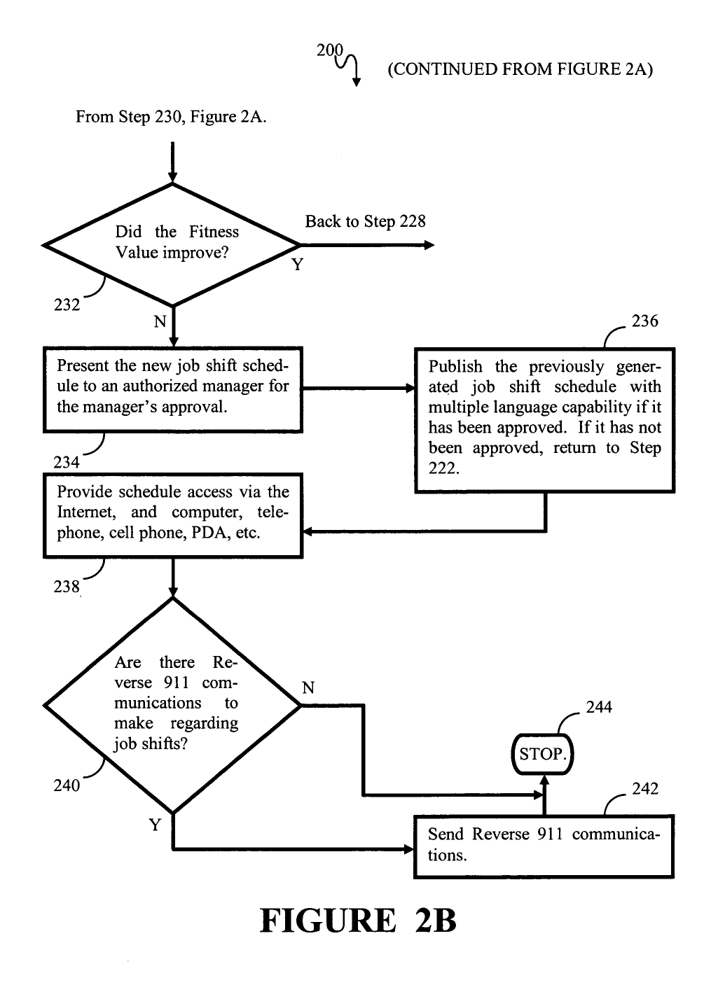

The functions of the modules are carried out according to the time management algorithm 200 illustrated in FIGS. 2A and 2B. In the preferred embodiment, time management software (e.g., “TimeTrekker™” software) is purchased by the principal (or on the principal's behalf), and then provisioned (Step 202) to begin the algorithm. Access to all of the data and control of the present-inventive time management software can be limited to a few management employees, while limited access can be provided to many or all of the principal's agents.

Next, the management agent creates a profile of the principal, including such information as the business name, the number of employees, contact information, etc. (Step 204). In Step 206, the management agent establishes security and access procedures for the time management software. An employee profile is entered for each employee in Step 208. The employee profile includes the employee name, job skills, and can even include other information such as the employee compensation, whether the employee is salaried or non-salaried, any special certifications, and other information.

The various departments of the principal company (or at least those which will use the time management software) are defined in Step 210. The specific jobs which will utilize the time management software are identified in Step 212, followed by defining or identifying the specific skills and other criteria needed to perform the jobs (Step 214). Next, the specific job shifts which will be managed by the software are identified in Step 216.

The present-inventive software-driven, time management method uses rules formally established by an authorized management employee to generate a job shift schedule. It also iteratively develops interpreted rules for automatically modifying job shift schedules. When schedules are modified by authorized managers, the software has the ability to learn from observation and repetition, conditions leading to schedule changes, and to deduce the rules over time used to implement the actual schedule changes. For example, although no formal rule may have been entered, a manager may desire not to schedule employees for back to back shifts, or shifts deemed too close in time. Consider the case of an employee who has just finished four shifts in the last three days. Managers may have a habit of not scheduling the employee for a shift on the next day for safety, health, liability or monetary reasons. The software will learn over time to modify or suggest modifying schedules to avoid the above-identified situation. The software may also learn that managers have a habit of revising suggested schedules so that at certain times, the seniority of the worker is taken into account with shift assignments, and that a pattern emerges over time.

The formal rules for job shift scheduling are created in Step 218. These rules can, of course, be periodically revised when desired.

In Step 220, employee availability is identified either by the management agent or the employee agent. The employee may also identify any particular job shift preferences that are appropriate.

A preliminary job shift schedule is generated by the algorithm in Step 222. In a fluid work environment, it is expected that shift changes will be needed or desired. When an employee scheduled for a shift on the previously generated schedule requests a shift change, a new schedule is generated (which may or may not honor the request, depending on the rules for job shift scheduling) in Steps 224 and 222 (again). If no requests for a job shift change have been received since the current job shift schedule was generated, the algorithm advances to Step 226.

A Fitness Value is calculated in Step 226, which is a numerical measure of the likelihood that, given known circumstances, a scheduling manager would keep a suggested schedule intact. For example, if an employee scheduled for a job shift complains of an injury not directly related to the job skills, previous experience may indicate that new job shift schedules should at least be considered. The job shift schedule is automatically modified according to formal and interpreted rules in Step 228. In an iterative loop, the algorithm attempts to hone in on what the most acceptable job shift schedule might be, calculating a new Fitness Value (Step 230) for each new schedule.

In Step 232 (see FIG. 2B), the algorithm determines whether the new Fitness Value has improved. If so, the algorithm returns to Step 228 for a further iteration. If not, the new schedule is presented to an authorized manager for approval (Step 234). In an alternate embodiment, an authorized manager may optionally allow the algorithm to automatically move to Step 236 without the need for approval.

An approved schedule is published (Step 236) by making it available to those needing to know the schedule in Step 238. It should be noted that in the preferred embodiment of the present invention, the job shift schedule has the capability of being viewed (e.g., via a computer, PDA, etc.) or heard (e.g., via a telephone) in more than one language, such as English, Spanish, French, Arabic, Chinese, etc.

Another aspect of the present invention is the ability to send Reverse 911 type communications to a principal's agents. These include important messages about canceled job shifts, temporary plant closings, or the need for certain employees to report to work as soon as possible, to name a few. Any Reverse 911 communications are sent to agents in Steps 240 and 242. The algorithm ends at Step 244.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

It is expected that there could be numerous variations of the design of this invention. For example, the tasks performed by agents include without limitation, skilled and unskilled labor, as well as professional services. Also, the back end of the system need not be under the direct control of the principal, but may be under the control of a third party.

Finally, the terminology used with respect to the present invention should be considered broadly. For example, the term agent may at times also encompass independent contractors.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A software method of creating and maintaining a schedule of the activities to be performed by agents on behalf of a principal entity, said method comprising:
a) creating the the principal profile;
b) identifying the principal's agents;
c) defining jobs to be performed by the principal's agents, said jobs being at least partially defined by identifiable skills needed to perform said jobs;
d) defining a scheduling period;
e) defining job shifts related to the temporal performance of said jobs during a scheduling period;
f) defining job criteria for matching particular agents to particular jobs;
g) identifying the availability of the principal's agents for job shift performance;
h) generating a job shift schedule based on elements b)-g);
i) automatically modifying said job shift schedule according to predefined rules and interpreted rules postulated by software according to previous scheduling and scheduling approval iterations;
j) determining a fitness value of a generated or modified schedule, based on adherence to predefined or interpreted rules;
k) repeating elements i) and j) until no improvement in said fitness value is realized;
l) via a principal's manager-agent, approving a job shift schedule; and
m) publishing an approved job shift schedule for availability to the principal's agents and manager-agents.

2. The method of claim 1, further comprising:
authorizing said manager-agent in element l) to approve said job shift schedule.

3. The method of claim 1, wherein elements b)-f) are at least partially and interactively carried out by an authorized manager-agent.

4. The method of claim 1, further comprising:
prior to the performance of element l), allowing an authorized manager-principal to modify a job shift schedule.

5. The method of claim 1, wherein the principal's agents at least partially enter data to carry element g).

6. The method of claim 1, wherein information reflecting the availability of the principal's agents is derived from a defined work schedule.

7. The method of claim 1, wherein information reflecting the availability of the principal's agents is derived from a defined vacation schedule.

8. The method of claim 1, wherein information reflecting the availability of the principal's agents is derived from a defined education class schedule.

9. The method of claim 1, wherein at least partial access to software carrying out said method is via the Internet.

10. The method of claim 1, wherein at least partial access to software carrying out said method is via an Intranet.

11. The method of claim 1, further comprising:
identifying job shift preferences of the principal's agents.

12. The method of claim 1, further comprising:
allowing the principal's agents to request changes from previous job shift assignments.

13. The method of claim 1, wherein said publishing is via the Internet.

14. The method of claim 1, wherein said publishing is via a telephonic device and audio messages.

15. The method of claim 1, wherein publishing is in the form of electronic communication targeted to specific agents, as a reminder of a portion of a job shift schedule pertaining to the targeted agents.

16. The method of claim 1, further comprising:
broadcasting communications to agents regarding exigent circumstances pertaining to a job shift schedule.

17. The method of claim 1, wherein said publishing further comprises:
broadcasting a job shift schedule capable of being understood in more than one language; and
allowing broadcast schedule recipients to choose a non-English version of a job shift schedule, if desired.

18. A software module configured to allow remote site work employee and such scheduling, comprising:
a) a principal profile module;
b) an agent module configured to identify an agent for the principal;
c) a jobs defining module, configured to be performed by the principal's agents, and being at least partially defined by identifiable skills needed to perform a job;
d) a scheduling period module configured to define scheduling periods;
e) a job shifts module, configured to define job shifts related to the temporal performance of the jobs during a scheduling period;
f) a job criteria module, configured for matching particular agents to particular jobs;
g) identifying module, configured to identify the availability of the principal's agents for job shift performance;
h) a job shift schedule generating module, configured to generate a job shift based on elements b)-g);
i) a modifying module, configured to automatically modify the job shift schedule according to predefined rules and interpreted rules postulated by software according to previous scheduling and scheduling approval iterations;
j) a fitness value module, configured to generate a fitness value of a generated or modified schedule, based on adherence to predefined or interpreted rules;
k) repeating elements i) and j) until no improvement in said fitness value is realized;
l) a job shift schedule approving module, configured to allow a principal's manager-agent to approve a job shift schedule; and
m) an approved job shift schedule module, configured to publish availability of job shifts available to the principal's agents and manager-agents.

19. The method of claim 18, wherein said software module is hosted via the Internet by an Application Service Provider.

20. A software module, configured to allow scheduling of shift work for employees, comprising:
a) an employee module, configured to hold all relevant information about at least one employee;
b) a job module, configured to hold all relevant information about at least one job;
c) a scheduling module, configured to schedule at least one employee, listed in the employee module, for at least one job, listed in the job module, during at least one shift schedule, listed in the scheduling module; and
d) a fitness value module, configured to generate a fitness value of the shift schedule, based on adherence to rules.
